(19) United States
(12) Patent Application Publication
(10) Pub. No.: US 2003/0129912 A1
(43) Pub. Date: Jul. 10, 2003

(54) Reinforcing material comprising volumized fibers and method for producing said material

(76) Inventor: Klaus K. Kolzer, Hilden (DE)

Correspondence Address: Nixon & Vanderhye, 8th Floor, 1100 North Glebe Road, Arlington, VA, 22201-4714, US

(21) Appl. No.: 10/276,706

(22) PCT Filed: Mar. 12, 2002
(86) PCT No.: PCT/EP02/02692

(30) Foreign Application Priority Data
Mar. 26, 2001 (DE) 101 14 708.2

(51) Int. Cl. B32B 5/06; B05D 1/12; D04H 1/06; B32B 27/02; D04H 5/02; D04H 3/10

(52) U.S. Cl. 442/387; 427/180; 428/105; 428/107; 428/113; 442/388; 442/352; 442/358; 442/359; 442/393; 442/417; 442/402

(57) ABSTRACT

The invention relates to a reinforcing material formed from bulked fibres that are combined in the form of a mat or a nonwoven. The bulked fibres differ as regards the material or degree of bulking. Alternatively or in addition, unbulked fibres are used.

In the process for the production of the reinforcing material, the endless elementary threads having a high modulus of elasticity arranged parallel to one another in a roving, yarn or slightly twisted yarn are forced apart or separated from one another with an aqueous binder-containing suspension of particles of the unblown precursor of the hollow plastics spheres of particle size ranging from 5 to 10 μm and the resultant interstices are largely filled with the particles, and the material thus obtained is subjected for the necessary time to the temperature required for the blowing process of the particles of the precursor, and this is processed further to form a mat using rovings, yarns or slightly twisted yarns that have been variously blown or not blown, and/or using rovings, yarns or slightly twisted yarns that consist of other materials. The reinforcing material is used for the production of lightweight laminates of thermosets.

Compared to the prior art lightweight laminates with an excellent loading capacity can be produced.

### DESCRIPTION

The present invention relates to a reinforcing material for thermosets, a process for its production, as well as its use.

In the production of moulded parts from plastics materials increasing efforts are being made both for structural and economic reasons to reduce the weight without adversely affecting the mechanical strength properties.

By reinforcing plastics materials with fibres, so-called fibre composite materials are obtained that are characterised by a substantially higher modulus of elasticity, i.e. a higher rigidity and thus a higher loading capacity, compared to non-reinforced plastics materials. In particular fibre composite materials of thermosets, such as conventional aminoplasts and phenoplasts, epoxide resins (EP resins), polyester resin (UP resins) and other reaction resins are widely used in multifarious areas of application, including inter alia as hardenable moulding compositions, laminated composites, casting resins or for surface protection.

Glass fibre-reinforced epoxide or polyester resins are among the most commonly used fibre composite materials. Moulded parts of this material are produced by wetting the glass fibres with the liquid thermosetting resins and adding them to a mould. Hardening is effected by a catalyst added to the liquid plastics resin. Glass fibre-reinforced plastics materials are formed and processed either without application of pressure or by various low pressure methods, and more specifically preferably into large moulded parts such as hulls, vehicle parts, storage containers, pipes, etc., which are characterised by an extremely high service durability combined with low weight. The service durability and strength properties of such materials depend on the one hand on the quality of the reinforcing fibres and resins that are used, and on the other hand on the weight ratio of the reinforcing fibres to the resin matrix. The strength values are better the higher the proportion by weight of the reinforcing fibres.

In the production of large-volume moulded parts as well as in the large-scale production of smaller moulded parts, where it is not economically feasible to manufacture expensive compression moulds, processes not involving pressure are employed. These pressureless processes include for example hand lamination, in which the moulded part is built up in layers to the desired material strength from sheet materials such as mats, wovens, fleeces and the like that are wetted with liquid resin.

Coiling processes in which resin-impregnated reinforcing strips or fibre strands are coiled on a mandrel or cylindrical formers and hardened also operate without application of pressure. In the drawing process reinforcing strips or fibre strands are also wetted with resin and finally drawn through profiled dies. The proportion of reinforcing fibres in the overall weight of a fibre composite material, which is decisive for the strength properties, can however be influenced only within certain limits in pressureless processes. When impregnating reinforcing fibres with liquid resins the interstices between the elementary threads are filled with resin corresponding to the suction capacity of the fibres.

The proportion of the reinforcing fibres in the total weight is thus less the greater the suction capacity of the reinforcing fibres referred to the volume.

The glass fibres commercially available as reinforcing material for fibre composite materials have qualities conventionally available on the market with a defined resin absorption capacity, which enable the manufacturer to calculate the specific weight and the overall weight of a moulded article. For example, glass fibre mats consisting of chopped or endless strands absorb about 70 wt. % to 75 wt. % of resin, whereas the absorption capacity of glass fibre woven fabrics of yarns, twists or rovings is only about 40% to 70%.

With nonwovens, in which the yarns, twists or rovings are not woven together but are joined to one another at the crossing points by stitched threads, the resin absorption capacity is also about 40% to 65%.

Accordingly, with laminates that are produced from glass fibre mats a specific weight of ca. 1.5 to 1.7 is achieved, whereas the specific weight of wovens and nonwovens is ca. 1.7 to 2.0.

In order to reduce the weight of plastics moulded parts without a loss of mechanical strength, with the same proportion of reinforcing fibres the resin may partially be replaced by fillers whose specific weight is lees than that of the impregnating resin. Accordingly lightweight fillers are suitable, in particular so-called hollow body fillers, also termed microspheres, which may be of inorganic as well as organic nature. Hollow glass microspheres constitute a lightweight filler that has the low specific weight necessary to reduce the density. Such hollow microspheres may also consist of a polymeric organic material and are obtainable for example under the trade name Expancel® with a thermosetic shell consisting of a vinylidene chloride/acrylonitrile copolymer. The grain size is between 50 and 300 μm and the density is about 20 to 40 kg/m³.

The unblown precursor of these hollow body fillers, for example based on polyvinyl chloride or vinylidene/acrylonitrile copolymers with a blowing agent such as for example isobutane, is also commercially available. The unblown particles (for example unexpanded Expancel®) have particle sizes of 5 to 10 μm. For the blowing operation they are subjected to temperatures of about 80° C. to 150° C., which correspond to the softening point of the material of the microspheres. As soon as the softening point has been reached, the enclosed blowing gas evaporates and inflates the individual filler particles to form a hollow sphere.

On account of the low weight of the hollow body fillers attempts have been made to incorporate them, by mixing them with the laminating resin, into fibre composite materials in order to reduce the weight of the latter. However, with this method the viscosity and thus the laminating behaviour of the impregnating-resins are adversely affected and it is not possible to incorporate the relatively coarse grain hollow body fillers into the interstices of the reinforcing fibres, but instead the fillers are retained on the surface. A further difficulty is that the sensitive hollow body fillers cannot withstand large mechanical stresses, with the result that they are partially destroyed as soon as they are stirred into the laminating resin or during the actual laminating process and accordingly can no longer contribute to the envisaged weight reduction.

It is also known to spray the unexpanded microspheres together with the latex of a hardenable binder onto a strip of textile staple fibres and then heat the resultant strip to the softening temperature of the thermosetic material of the microspheres. In this way a very voluminous, nonwoven structure is obtained having a high water adsorption capacity, which can be used for dusters or wiping cloths as well as bandaging material (U.S. Pat. No. 3,676,288). Such bonded fibre strips have also already been impregnated with a liquid resin-hardener mixture and used for the production of moulded fibre-reinforced plastics articles. However, in this case they are suitable only as core material on account of their low strength, and the thermosets have to be reinforced with endless strands having a higher modulus of elasticity than that of the hardened thermosets (DE-B-24 33 427).

From European patent specification EP 0 222 399 B1 it is known to provide the processing manufacturer with a finished reinforcing material that avoids the aforedescribed disadvantages of incorporating the hollow body fillers into the fibre composite material and that enables the specific weight of the fibre composite material to be reduced without adversely affecting the strength. In order to produce such a reinforcing material the endless elementary threads with a high modulus of elasticity and arranged parallel to one another in a roving, yarn or slightly twisted yarn are forced apart or separated from one another with an aqueous binder-free suspension of particles of the unblown precursor of the hollow spheres of plastics material having a particle size of 5 to 10 μm.

The resultant interstices are largely filled with the particles and the material thus obtained is subjected for the necessary time to the temperature required for the blowing process of the particles of the precursor. A reinforcing material for thermosets in the form of a roving, yarn or slightly twisted yarn consisting of endless elementary threads arranged parallel to one another and having a high modulus of elasticity is thereby obtained. A substantial proportion of the parallel, binder-free elementary threads are forced apart or separated from one another. The interstices between the elementary threads are largely filled by hollow spheres of plastics material 20 to 300 μm in diameter. The resin absorption capacity and the specific weight is thereby reduced compared to the aforementioned prior art.

It has been found experimentally however that although the embedding of the hollow spheres does indeed achieve a considerable saving in weight, the incorporated hollow spheres produce a structural compaction that prevents the desired fast percolation with plastics resins and a rapid degassing.

The object of the present invention is to achieve good impregnation and degassing properties with low resin absorption in a reinforcing material.

This object is achieved by a reinforcing material having the features of the main claim as well as by a process having the features of the subclaim. Advantageous modifications are disclosed in the dependent claims.

The reinforcing material for thermosets according to the claims is present in the form of a mat or nonwoven that has bulked fibres. A bulked fibre is one in which hollow spheres are incorporated. In contrast to the prior art the bulked fibres that are used consist either of different materials, and/or unbulked fibres and/or variously bulked fibres are provided in addition.

It has been shown experimentally that in this way the percolation and degassing properties are substantially improved compared to the prior art known from printed specification EP 0 222 399 B1. The resin consumption is moreover very low in the further processing.

An advantageous modification relates to a nonwoven formed from the fibres, in which the fibres are sewn only after the bulking. The threads required for the sewing are not fibres within the meaning of the main claim. Compared to the prior art according to printed specification EP 0222399 B1, the balloon-like blowing of a fibre strand is not restricted to the region between the crossing points of the warp and weft. Constrictions at the crossing points are thus avoided. The result is a substantially more uniform material surface since the sewing threads match the dimensions of the bulked fibres. Bulked and unbulked fibres may also be combined with one another. A nonwoven in which bulked fibres and unbulked fibres are arranged in layers leads to an end product having a particularly high strength. The flow of the bulked fibres crosses the flow of the unbulked fibres. Bulked fibres are arranged parallel to one another. Unbulked fibres are also arranged parallel to one another. The flow of the sewing threads crosses the flow of the unbulked fibres as well as the flow of the bulked fibres. Two layers of unbulked fibres preferably enclose one layer of bulked fibres, thereby producing products having a high strength.

In general in subsequent sewing, bulked and unbulked thread strands may be arbitrarily combined to produce specific properties in order for example to influence the processing properties of the nonwoven. Thus, apart from bulked fibres with a more compact material structure, other fibres with a very open material structure may be “laid”. These unbulked fibres may consist of plastics strands, plastics monofilaments, hollow filaments or glass fibre strands. In this way it is possible for example to adjust individually the percolation properties of the nonwoven for the processing procedures, in which a rapid resin flow and a quick degassing are important. Such processes include for example the injection process, vacuum film process, RTM (resin transfer moulding), SCRIMP process, etc.

Accordingly it is also possible to control and adjust the interspacing between the thread strands and thereby ensure, by means of a suitable mixture of different thread qualities and by means of the interspacings between the individual threads, that “percolation channels” are formed. It may be left to the person skilled in the art to formulate suitable mixtures for the respective intended application. In the case of the objects according to the invention the resin absorption capacity and the specific weight of the conventional reinforcing materials for thermosets in the form of rovings, yarns or slightly twisted yarns or wovens, knitted fabrics or nonwovens produced therefrom are permanently reduced without the strength properties of composite materials produced therewith being adversely affected. The endless elementary threads with a high modulus of elasticity that are as a rule arranged parallel to one another in the roving, yarn or twist (covered here by the generic term “fibres”) are forced apart or separated from one another with an aqueous binder-free suspension of particles of the unblown precursor of the hollow spheres of plastics material and the-resultant interstices are largely filled with the particles and the material thus obtained is subjected for the necessary time to the temperature required for the blowing process of the particles of the precursor.

Where the terms endless fibres or threads are used here, these are understood to mean, in contrast to textile fibres and/or staple fibres that are at most only a few centimetres long, the very large lengths in which the conventional rovings, yarns or slightly twisted yarns are commercially available for reinforcing purposes, and/or are also present in the wovens, knitted fabrics or nonwovens produced therefrom.

Due to the production process the elementary fibres in strands, parallel rovings, endless yarns, etc. are as a rule provided with more or less strongly adhesive sizes. In the treatment of the endless strands with the aqueous suspension of the unblown microspheres, the water-soluble sizes or binders are dissolved in water and thereby removed. In this way the elementary fibres are separated from one another and at least forced apart, so that at the same time the particles of the unblown precursor of the hollow spheres can penetrate the interstices thereby formed and can largely fill the latter. The separation of the elementary threads from one another and the incorporation of the unblown microspheres thus preferably takes place at the same time as the treatment of the endless strands with the aqueous suspension. It is however also possible to remove the sizes or binders adhering to the rovings, yarns or twists in a separate operating stage before the incorporation of the hollow spheres. If the size or adhesive is not sufficiently water-soluble, a solvent can also be used for this purpose.

The separation of the elementary threads from one another and/or the incorporation of the unblown hollow spheres into the fibre strands may be accomplished for example by subjecting the fibre strands in the aqueous bath to an intensive fulling process in which the parallel-lying elementary threads of the reinforcing fibres are forced apart, thereby enabling a thorough penetration by the filler particles. In contrast to the prior art known from printed specification EP 0 222 399 B1, a commercially available binder, for example an acrylate binder, is added in this case to the aqueous bath. The fibre strands may be subjected to high pressures of for example 2 to 10 bar from the suspension in order to achieve the desired mobility of the elementary threads with respect to one another and to incorporate the unblown microspheres therebetween. The same applies as regards the treatment of wovens, knitted fabrics or nonwovens made from the endless fibres. After the incorporation of the particles the fibre strands or strips are scraped (doctored) by suitable means, for example rubber lips or eyelets, so that no unblown hollow spheres that could interfere in the further processing procedure remain loose on the surface. The fibre strands or strips treated in this way are then drawn through a drying tunnel and there dried by air and heat. The dry spheres that are now embedded between the fibre strands cannot, on account of the binder, fall out of the rovings, yarns or slightly twisted yarns together with the parallel-arranged, endless elementary threads, irrespective of whether or not the strands are under tension and the elementary threads clamp or do not clamp the spheres lying between them. On account of the binder the processing procedure is considerably less complicated and simpler compared to the previously known processing procedure.

After the drying stage the fibre strands or strips are drawn at a temperature of 80° to 150° C. through a heating furnace, the heating time being about 15 seconds to about 15 minutes. Due to the heating effect the blowing gas expands the microspheres up to a diameter of about 20 to 300 μm, and the expanding hollow microspheres force apart the elementary threads of the fibres and/or of the fibre strand and largely fill the interstices, as a result of which the diameter of the fibre strand or the thickness of the sheet material produced therefrom can be increased 2-fold to 30-fold. In contrast to the prior art, it is no longer necessary to control the blowing process so that the microspheres slightly sinter together towards the end of the process and at the same time bond to a certain extent to the elementary threads. What is more, this sintering step is in fact very difficult to accomplish since a very narrow temperature range has to be maintained.

A reinforcing material suitable for thermosets, which contains hollow body fillers of a particle size between 20 and 300 μm and which in this form can be made directly available to the processing manufacturer, is obtained by the process. The resin absorption capacity can be adjusted continuously, depending on the amount of filler particles added and the intensity of the heat treatment, up to a point at which no further absorption is possible.

Glass fibres are mainly suitable on grounds of price as fibre material for the production of the thermosetting reinforcing material, though the reinforcing material may be modified by the use of other fibres having a high modulus of elasticity, such as carbon or aramide fibres.

Reinforcing fibres in the form of wovens or nonwovens have proved particularly suitable for the provision with hollow body fillers. The use of nonwovens is preferred if a particularly high strength is to be achieved.

The nonwovens already mentioned above are produced for example by cutting rovings, yarns or slightly twisted yarns of the endless fibres into defined lengths, e.g. the production width of about 100 cm, using special machines, for example “Malimo” automatic stitching machines, and joining these together, like the rungs of a rope ladder, with active threads to form a sheet material. In this case the fibre strands pass through the production process in a crosswise manner and not in the longitudinal direction. According to the “Malimo” technique the crosswise-lying fibre strands can in addition be joined to longitudinally-lying fibre strands by stitching the strands together at their crossing points.

Interweaving is another possible way of joining endless fibre strands to form a sheet material. The woven structure plays a substantial role as regards the state of the end product. In contrast to the prior art, in this case the fibres and not the finished sheet materials are blown before the interweaving. Constrictions at warp and weft crossing points are thereby avoided.

For example, if several layers of such sheet materials are placed on top of one another the individual layers interlock, resulting in a high interlaminar shear strength in the case of laminated materials.

In the prior art constrictions were desirable on account of the channels thereby formed, in order to produce an excellent flow behaviour and a uniform distribution of the liquid resin within the moulded part when the material was used in a pressing procedure or in a vacuum injection. These constrictions are now no longer necessary since the problem has been solved in an improved manner in the way described above.

In both the strand-shaped material and the flat reinforcing material the hollow spheres are preferably incorporated in such an amount that the final thickness is 2 to 30 times, in particular 5 to 10 times the thickness of the starting material.

According to the process fibres are variously bulked by forcing apart first fibres with a first aqueous binder-containing suspension and second fibres with a second aqueous binder-containing suspension, the first aqueous binder-containing suspension containing a different binder and/or a different amount of binder to the second suspension. A desired different degree of bulking can be achieved in this way.

The amount of acrylate binder that is used may be 1 to 50 wt. % referred to the specific weight of the expanded spheres.

Alternatively fibres may be bulked to different degrees by bulking first fibres and second fibres, the first fibres being twisted more strongly than the second fibres. The differently twisted fibres are then bulked using the same process steps.

A different bulking within the context of the invention is achieved if the different bulking has been accomplished specifically for example in the aforedescribed manner. First and second fibres have thus been controllably bulked by different amounts. Fibre strengths differing by at least 50% are then produced for example. The different fibre strengths may also differ by a factor of 2 to 3. The reinforcing materials are preferably used for the production of lightweight laminates from thermosets.

### EXAMPLE

A parallel roving with 12240 endless elementary glass fibres is drawn at a speed of 2 m per minute from a 10000 m long storage coil and passed through a bath of an aqueous suspension containing 10 wt. % of unexpanded Expancel®. The suspension also contains an acrylate binder. 1 to 50 wt. % of a commercially available acrylate binder was employed referred to the weight of the spheres that are used. The strand is subjected in the bath to ultrasound vibrations from a commercially available generator. Externally adhering particles and excess water are stripped off by passing the strand through a suitably dimensioned eyelet. The parallel roving treated in this way has absorbed 8 wt. % of particles and is passed through a drying tunnel into which hot air at 80° C. is blown. The fibre strand is then passed through an oven heated by infrared heaters, and leaves the oven at a temperature of 150° C. The residence time in the oven is 3 minutes. The hollow spheres have an average diameter of 60 μm and the diameter of the fibre strand has increased by a factor of 10.

Such fibres are processed further in a manner known per se inter alia with unbulked fibres to form nonwovens.

A reinforcing material in which variously bulked fibres have been processed was produced. The diameter differs by at least 100%.

A further reinforcing material was formed by bulked chopped fibre staple.

Bulked and unbulked fibres were used in a further reinforcing material.

Bulked threads as well as endless threads with layers of bulked and chopped staple fibres with a length of 0.5 to 10 cm were used in yet a further reinforcing material.

The reinforcing materials used for the solution of the object of the invention comprised for example fibres that differ as regards their hardness and/or that have a different solubility after wetting with the resin matrix that is used.

Alternatively or in addition to the aforedescribed ultrasound treatment, the fibres may be sprayed with the suspension or rolled or calendered in the aqueous suspension.

1. Reinforcing material formed from bulked fibres that are combined in the form of a mat or nonwoven, characterised in that the bulked fibres differ as regards the material and/or the degree of bulking and/or the unbulked fibres that are used.

2. Reinforcing material according to claim 1, characterised in that at least one layer of bulked fibres that are joined by a stitching or needle process is provided.

3. Reinforcing material according to claim 1 or 2, in which two layers of bulked fibres in which the individual layers are aligned differently are joined to one another by a stitching or needle process.

4. Reinforcing material according to one of the preceding claims, in which at least one layer or ply consists of bulked threads and a further layer or ply consists of unbulked threads.

5. Reinforcing material according to one of the preceding claims, in which one or more thread layers with different alignments of the fibres consists/consist of a mixture of bulked and unbulked threads.

6. Reinforcing material according to one of the preceding claims, in which the bulked threads are produced by embedding thermosetic hollow microspheres.

7. Reinforcing material according to one of the preceding claims, in which the bulked threads consist of strands, yarns, twists or rovings.

8. Reinforcing material according to one of the preceding claims, in which the bulked threads consist of glass fibres, plastics fibres (e.g. polyester), aramide fibres or carbon fibres.

9. Reinforcing material according to one of the preceding claims, in which variously bulked fibres are provided whose diameters differ by at least 50%, preferably by at least 100%.

10. Reinforcing material according to one of the preceding claims, formed by bulked chopped fibre staple.

11. Reinforcing material according to one of the preceding claims, which comprises bulked threads as well as endless threads with layers of bulked and chopped staple fibres having a preferred length of 0.5 to 10 cm.

12. Process for the production of a reinforcing material according to one of the preceding claims, characterised in that endless elementary threads having a high modulus of elasticity arranged parallel to one another in a roving, yarn or slightly twisted yarn are forced apart or separated from one another with an aqueous binder-containing suspension of particles of the unblown precursor of the hollow plastics spheres of a particle size ranging from 5 to 10 μm and the resultant interstices are largely filled with the particles, and the material thus obtained is subjected for the necessary time to the temperature required for the blowing process of the particles of the precursor, and this is processed further to form a mat using rovings, yarns or slightly twisted yarns that have been blown to various degrees or not blown, and/or using rovings, yarns or slightly twisted yarns that consist of other materials.

13. Process for the production of a reinforcing material according to the preceding claim, in which the fibres are variously bulked by forcing apart first fibres with a first aqueous binder-containing suspension and second fibres with a second aqueous binder-containing suspension, the first aqueous binder-containing suspension containing a different binder and/or another amount of binder than the second suspension.

14. Process for the production of a reinforcing material according to one of the two preceding process claims, in which fibres are variously bulked, by bulking first fibres and second fibres, the first fibres being twisted more strongly than the second fibres.

15. Use of the reinforcing material according to one of claims 1 to 11 for the production of lightweight laminates of thermosets.
